(19) United States
(12) Patent Application Publication
(10) Pub. No.: US 2006/0189349 A1
(43) Pub. Date: Aug. 24, 2006

(54) Systems and methods for automatic uploading of cell phone images

(75) Inventors: Louis J. Montulli, Reno, NV (US); James H. Clark, Redwood City, CA (US); Jeffrey N. Whitehead, San Jose, CA (US); Jason F. Harrison, San Jose, CA (US); Aleksander K. Totic, San Francisco, CA (US); Garrett A. Blythe, Cupertino, CA (US)

Correspondence Address: TRAN & ASSOCIATES, 6768 MEADOW VISTA CT., SAN JOSE, CA, 95135, US

(73) Assignee: Memory Matrix, Inc.

(21) Appl. No.: 11/064,259

(22) Filed: Feb. 24, 2005

(51) Int. Cl. H04M 1/00

(52) U.S. Cl. 455/556.1; 455/41.2; 348/371

(57) ABSTRACT

Systems and methods are disclosed for communicating image data in a cell phone with an integrated camera by capturing image data using the integrated cell phone camera; detecting when the cellular device is in range of a wireless local area network (WLAN); and transferring the image data from the cell phone camera to a remote computer over the WLAN without an explicit user request.

### BACKGROUND

Technological advancements in communication technologies have permitted the introduction, and popularization of usage, of new types of communication systems. Communication devices of both increased processing capacities and of smaller sizes are able to be utilized in applications and in situations not previously possible or practical.

New wireless communication systems and communication devices operable therein, have been made possible as a result of such advancements. A cellular communication system capable of communicating packet data is exemplary of a new wireless communication system made possible as a result of technological advancements. A cellular communication system includes a network infrastructure which is installed in a geographical area and affixed in position. Mobile terminals operable in a cellular communication system communicate by way of the network infrastructure.

Additional types of communication systems are also available to take advantage of the advancements in communication technologies. For instance, ad hoc, i.e., infrastructure-free, communication systems such as the Bluetooth standard set forth an ad hoc, communication system which provides for wireless connectivity of a large number of different devices. Bluetooth devices are connectable in an ad hoc manner by way of short-distance radio links, thereby to permit data to be communicated between such Bluetooth devices. U.S. Pat. No. 6,795,688 discloses a method in a wireless personal area network. An attribute setting constitutes a discretely variable value conforming to the location of the device. In one embodiment, the device and network incorporate communicative capability compliant with the Bluetooth specification.

U.S. Pat. No. 5,491,507 discloses a telephone which permits a user to transmit and receive pictures and speech with a casing held in one hand. A speaker is arranged at the upper end part of the front of the casing which is thin and vertically long, while a microphone is arranged at the lower end part thereof. A display panel and a control panel are interposed between the speaker and the microphone. A camera is mounted on the casing so as to be capable of altering its angle. The speaker is detachably mounted, and it is usable as an earphone when detached. The user's movements are not hampered during the transmission and reception, and the equipment can assume various communication or service attitudes conforming to the contents of information for the communications.

FIG. 1 shows an exemplary cell phone with a camera for taking pictures or videos. As mentioned in the '507 patent, the phone 1 is mainly constructed of the body 2 thereof which is thin and flat and which is in a vertically long shape, a camera 3 which is turnably mounted on the right side surface of the body 2, an ear pad 4 which is foldably mounted on the upper part of the front of the body 2, a speaker 6 which is arranged at the central part of the ear pad 4, an antenna 21 which is mounted on the right side of the top surface of the body 2, and a battery assembly 9 which is detachably mounted on the lower part of the rear surface of the body 2. In addition, a grip 35 (chamfered parts 35a) is formed extending from the rear surface of the handy type video telephone equipment 1 to both the side surfaces thereof. A display panel 11, a transmission/reception key 12, a termination key 13, a control panel 14, function keys 15, and a microphone 16 are arranged on the front surface of the body 2, in addition to the ear pad 4. The phone includes a processor and a memory, a communication device which includes a radio/video codec, a speaker, a display panel, a control circuit, a microphone, a battery, an antenna 21, and the camera 3. Additionally, Bluetooth and/or 802.11 transceivers are coupled to the control circuit so that the phone 1 can communicate with a WLAN.

Recently, smart phones such as AudioVox's SMT5600 run on Microsoft's Windows Mobile 2003 OS and contain built-in VGA cameras that take both still and video images. When finished with taking the photos, the user can save them to the phone or send them to friends via a multimedia message, Bluetooth, or an infrared port. In addition to Bluetooth, WiFi capable cellular phones have appeared. For example, Nokia's 9500 Communicator is a tri-band voice device with wide color screen and full keyboard, email, web and office applications, and the ability to connect to compatible company and public network via high-speed 802.11 Wireless LAN, GPRS and EDGE. With this device, the user can access the Internet without incurring cellular data charges whenever the user is within range of an 802.11 Wireless LAN.

Bluetooth can be used to transfer image and other data. For example, as noted in US Application Serial No. 20030157960, a Bluetooth equipped digital camera communicates with an intermediary electronic device such as a 3G cellular telephone. A user can take one or more pictures with the camera and then cause the camera to transfer one or more of the pictures through an intermediate electronic storage device such as a Bluetooth cell phone to a remote storage device. When the camera detects the memory to be full or nearly full, it initiates a connection to the cell phone, transfers data and then disconnects. In manual mode the user decides when to perform the transfer.

U.S. Patent Application 20030030731 discloses a digital camera and image processing system configured for transferring image data. Transferring means including wireless transmission, transmission through a telephone network, and copying image data to detachable memory modules. Recorded images are optionally previewed and selected for transmission prior to actual transmission. Wireless transmission may be through a cellular telephone network and may be to an internet-based image processing system configured to process digital images and optionally delivery them to a client. The digital camera optionally receives data from an internet based image processing system and/or from other digital cameras. In addition to image data transmission optionally includes processing preference data, user identifying data, and address data.

### SUMMARY

Systems and methods are disclosed for communicating image data in a cell phone with an integrated camera by capturing image data using the integrated cell phone camera; detecting when the cellular device is in range of a wireless local area network (WLAN); and transferring the image data from the cell phone camera to a remote computer over the WLAN without an explicit user request.

Implementations of the above systems and method can include one or more of the following. In one embodiment, the system automatic downloads images from a phone via Bluetooth or Wi-Fi protocol when in proximity of a home network or other device. The system enables the automatic transfer of multimedia data from a camera or cell phone when in proximity of a wireless hotspot. The system automatically senses when the multimedia device is in range of an appropriate wireless hotspot and begin a transfer of the data to an appropriate server over the network. This mechanism allows the user to take pictures or other multimedia and not have to go through an explicit export step. The data would be made available from the new server location for printing, sharing and archiving, and any other use. The portable device can be any of a number of digital appliances with Bluetooth and/or WiFi such as for example, a camera cell phone, a digital still or digital video camera, set-top box, game machine, photo appliance, and the like.

Advantages of the system may include one or more of the following. The system frees up the memory in the camera for taking more pictures without having to swap out memory cards as in conventional systems. Another advantage is that it affords the user the ability to wireless synchronize all associated multimedia assets, such as digital photos, and/or albums that contain digital data. Thus, if a particular multimedia asset is captured, the information can be automatically uploaded to a server and removed from the device's memory to allow additional pictures to be taken. This synchronization is accomplished efficiently and automatically by, in one embodiment, transparently transferring newly captured images whenever the device detects an available wireless network.

### BRIEF DESCRIPTION OF THE DRAWINGS

FIG. 1 shows an exemplary prior art cell phone with a camera for taking pictures or videos.

FIG. 2 shows an exemplary embodiment in accordance with the invention.

FIG. 3 shows another embodiment for securely transmitting image data.

FIG. 4 shows an exemplary Bluetooth personal area network for transferring image data from cell phones to an image server.

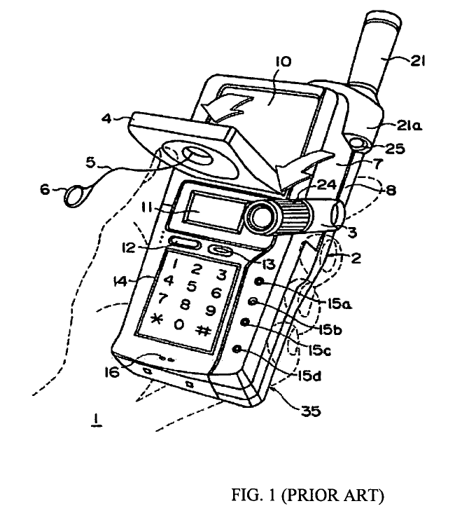

### DESCRIPTION

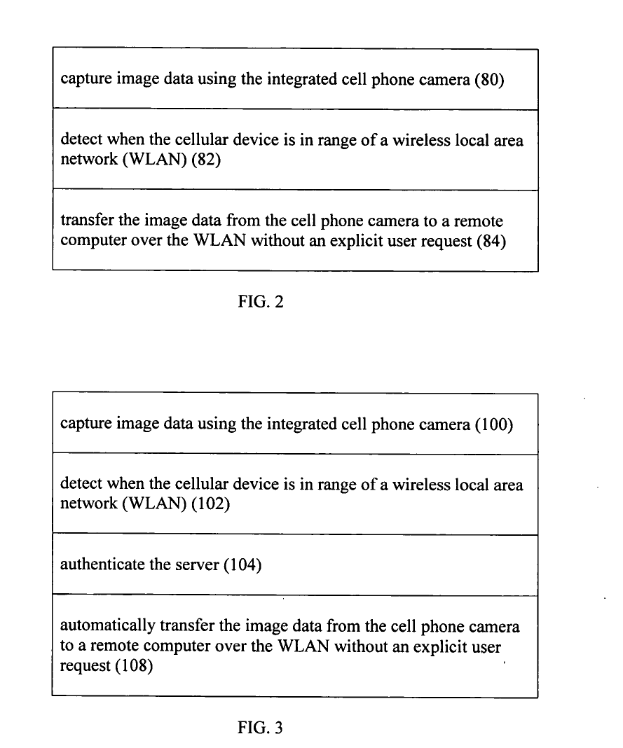

FIG. 2 shows an exemplary embodiment in accordance with the invention. In the process of FIG. 2, the system captures image data using the integrated cell phone camera (80); detects when the cellular device is in range of a wireless local area network (WLAN) (82); and automatically transfers the image data from the cell phone camera to a remote computer over the WLAN without an explicit user request (84).

FIG. 3 shows another embodiment for securely transmitting image data. In this process, the cell phone captures image data using the integrated cell phone camera (100). To minimize data transmission requirement a user may manipulate a recorded image, and the associated image data. The manipulations include a “save” option and a “delete” option. This embodiment also includes “transmit” and “mark” options. Button controls on the cell phone enable the selection of at least the delete and transmit options and optionally the save and mark options. These options for manipulating image data may be executed one image at a time or, alternatively, button controls may be used to “mark” a plurality of images for bulk manipulation of images and associated image data. Only saved images are transmitted over the WLAN. A number of images may be taken and stored on the cell phone.

Eventually, the user travels to his or her home or office where cell phone images are to be synchronized. The software on the cell phone detects when the cellular device is in range of a wireless local area network (WLAN) (102). When in range, the cell phone authenticates the server (104). Upon passing authentication, the system automatically transfer the image data from the cell phone camera to a remote computer over the WLAN without an explicit user request (108).

For security, link encryption for either Bluetooth or 802.11 transmissions is done as a stream cipher using 4 LFSR (linear feedback shift registers). The sum of the width of the LFSRs is 128, and the effective key length is selectable between 8 and 128 bits. Key generation and authentication is done using an 8-round SAFER+ encryption algorithm.

In one embodiment, to minimize “bluesnarf attack” the cell phone's ‘visible’ mode is turned off. Additionally, a login process is performed in another embodiment where the user enters a user ID and a password before data transmission can occur.

The cell phone can communicate over the WLAN to a server that is connected to the Internet. As would be evident to one of ordinary skill in the art, the server includes a CPU, hard disk, memory, and Internet access such as a modem, network interface card, or a cable modem. Having access to the Internet, the server can transfer image data from the cell phone to a photofinisher. When within range of the WLAN, the system transfer data automatically to the storage space of the remote home-based server from the data storage device of the user's cell phone. The cell phone's WLAN transceiver then transmits the pictures over the WLAN. Alternatively, when WLAN is not present and the cell phone data storage device is almost full, the cell phone can transmit images through the cellular network (preferably using 3G) to the home-based server for storage thereon. In that case, the cell phone calls the server's modem and transmits data to the server over the POTS network.

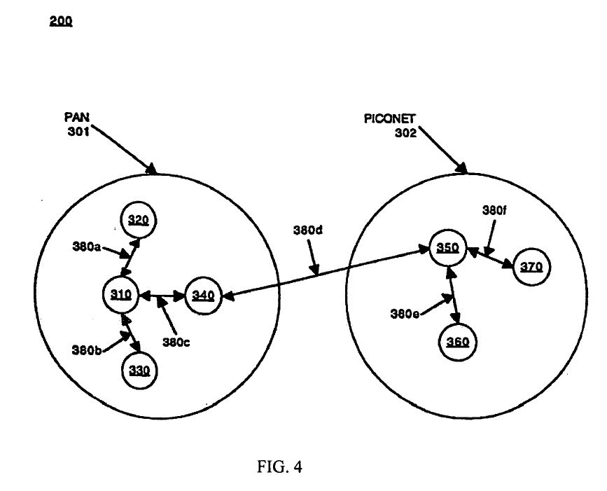

FIG. 4 illustrates the topology of one exemplary Bluetooth network 200 of devices that can be coupled using wireless connections in accordance with one embodiment. Devices 310, 320, 330 and 340 are coupled to a Bluetooth personal area network (PAN) 301 using wireless connections 380a-c. Devices 350, 360 and 370 are coupled in piconet 302 using wireless connections 380e-f. PAN 301 and piconet 302 can communicate using wireless connection 380d. Although wireless connection 380d is shown between devices 340 and 350, it is appreciated that each of the devices in PAN 301 and piconet 302 can be in communication with each other.

Devices 310 can be a server, while devices 320-370 and 390 can be cell phones, among other devices. The cell phones contain captured image data using the integrated cell phone cameras. When the cell phones 320-370 detect they are in range of the piconet, they authenticate with the server device 310 and transfers image data from the cell phone camera to a server 310 over the PAN 301 without an explicit user request.

In another embodiment, the cell phones can communicate with 802.11 WLAN. For example, the cell phone can be a Nokia 9500 Communicator with images stored thereon. The cell phone connects to the network via high-speed 802.11 Wireless LAN. Whenever the user is within range of an 802.11 Wireless LAN, the cell phone transfers the image data from the cell phone camera to a remote computer over the WLAN without an explicit user request. The remote computer can be an image server or can simply be a desktop computer configured with suitable software to poll the cell phones and retrieve image data from the cell phones to a directory.

In this disclosure and claims, the terms “transfer” and “transmit” or their derivatives are may be equivalent when transference is done through transmission. Images include image data and image data includes images. Also, in this disclosure and claims, the term “automatically” is meant to mean that something is done without the need for further input from a user.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting. For example, although the buffer memory is described as high speed static random access memory (SRAM), the memory can be any suitable memory, including DRAM, EEPROMs, flash, and ferro-electric elements, for example. The invention may be implemented in digital electronic circuitry or in computer hardware, firmware, software, or in combinations of them.

Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

While the above embodiments have involved application of luminescent substances to dental structures, the invention is applicable to all non-opaque surfaces.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for communicating image data in a cell phone with an integrated camera, comprising:
capturing image data using the integrated cell phone camera;
detecting when the cellular device is in range of a wireless local area network (WLAN); and
transferring the image data from the cell phone camera to a remote computer over the WLAN without an explicit user request.

2. The method of claim 1, wherein the remote computer is a server.

3. The method of claim 1, comprising printing the image data.

4. The method of claim 1, comprising distributing the image data.

5. The method of claim 1, comprising archiving the image data.

6. The method of claim 1, comprising communicating over a Bluetooth protocol.

7. The method of claim 1, comprising communicating over an 802.11 protocol.

8. The method of claim 1, comprising automatically transmitting images when a threshold is reached.

9. The method of claim 8, wherein said threshold is user programmable.

10. The method of claim 1, comprising automatically deleting the image data after transferring the data to the remote computer.

11. An apparatus for communicating image data in a cell phone with an integrated camera, comprising:
means for capturing image data using the integrated cell phone camera;
means for detecting when the cellular device is in range of a wireless local area network (WLAN); and
means for transferring the image data from the cell phone camera to a remote computer over the WLAN without an explicit user request.

12. The apparatus of claim 11, wherein the remote computer is a server.

13. The apparatus of claim 11, comprising means for printing the image data.

14. The apparatus of claim 11, comprising means for distributing the image data.

15. The apparatus of claim 11, comprising means for archiving the image data.

16. The apparatus of claim 11, comprising means for communicating over a Bluetooth protocol.

17. The apparatus of claim 11, comprising means for communicating over an 802.11 protocol.

18. The apparatus of claim 11, comprising means for automatically transmitting images when a threshold is reached.

19. The apparatus of claim 18, wherein said threshold is user programmable.

20. The apparatus of claim 11, comprising means for automatically deleting the image data after transferring the data to the remote computer.
